(19) United States
(12) Patent Application Publication
(10) Pub. No.: US 2004/0147857 A1
(43) Pub. Date: Jul. 29, 2004

(54) Positioning device for massaging machine

(76) Inventor: Tsung-Chen Huang, Pusiiing Village (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/352,088

(22) Filed: Jan. 28, 2003

(51) Int. Cl. A61H 7/00

(52) U.S. Cl. 601/18; 601/70; 601/134

(57) ABSTRACT

A massage machine includes a casing having two massage members movably connected thereto and a plurality of legs are connected to an underside of the casing. Each leg has a suction disk connected thereto and a connection bar is connected between two suction disks. The suction disks fix the massage machine on a table and can be easily pulled off by lifting the connection bar.

### FIELD OF THE INVENTION

The present invention relates to a massage machine which includes four legs each have a suction disks. A connection bar is connected between two suction disks on each side of the machine so that the two suction disks can be easily removed by pulling the connection bars.

### BACKGROUND OF THE INVENTION

A conventional portable massage machine includes a casing with at least one massage member which is driven by a motor so that the massage member moves up and down or rotates to provide massage feature for the users. The users hold the massage machine and shift the massage machine to desired positions of the body. Although the massage machine is portable so that it can be easily removed from place to place, the vibration transferred to the hands of the users makes the user feel not good. When the users want to put the massage machine on a table and put limbs on the massage member, the massage machine moves on the table because of the vibration.

The present invention intends to provide a positioning device for the massage machine so as to be easily positioned at a fixed point on the table.

### SUMMARY OF THE INVENTION

In accordance with one aspect of the present invention, there is provided a massage machine which includes a casing having two massage members movably connected thereto and a plurality of legs are connected to an underside of the casing. Each leg has a suction disk connected thereto and a connection bar is connected between two suction disks.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the massage machine of the present invention;

FIG. 2 is a perspective view to show the massage machine of the present invention, wherein a cover is connected between the two massage members;

FIG. 3 is a perspective view to show the massage machine of the present invention, wherein two top caps are mounted the two massage members;

FIG. 4 is a side view of wherein the massage machine of the present invention;

FIG. 5 shows the connection bar is lifted by a user's finger, and

FIG. 6 shows another side view of the massage machine of the present invention.

### DETAILED DESCRIPTION OF THE PREFERRED EMBODIMENT

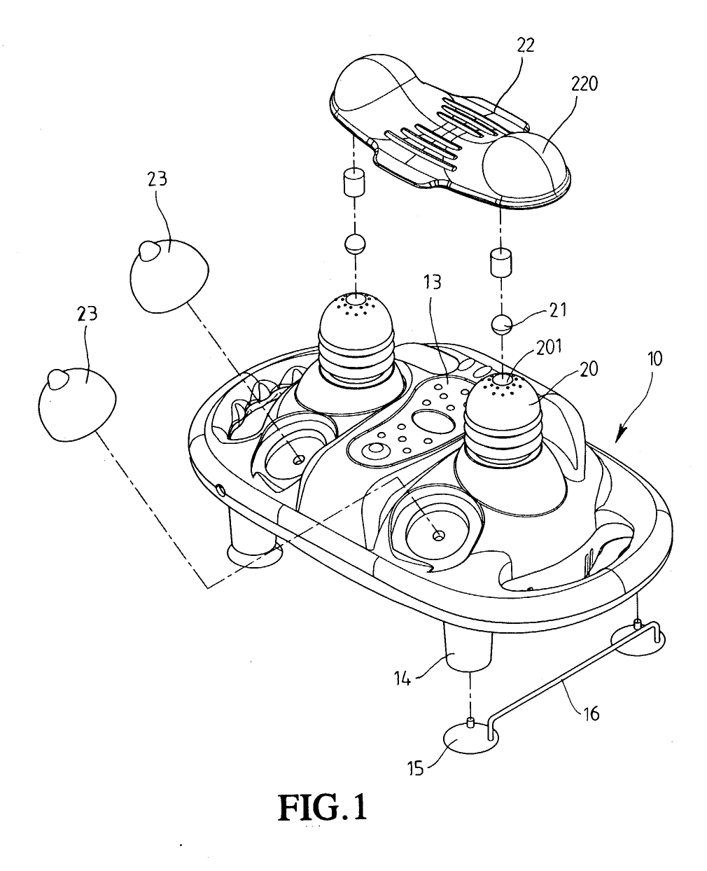

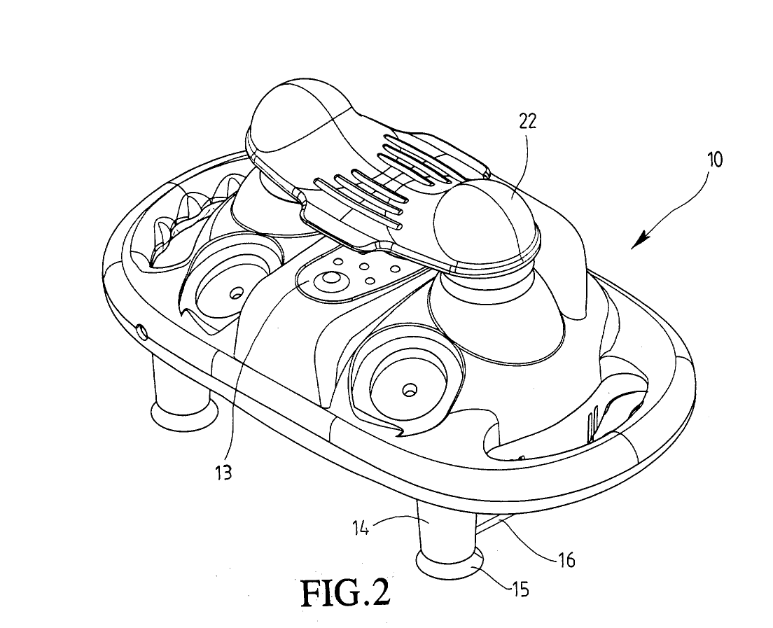

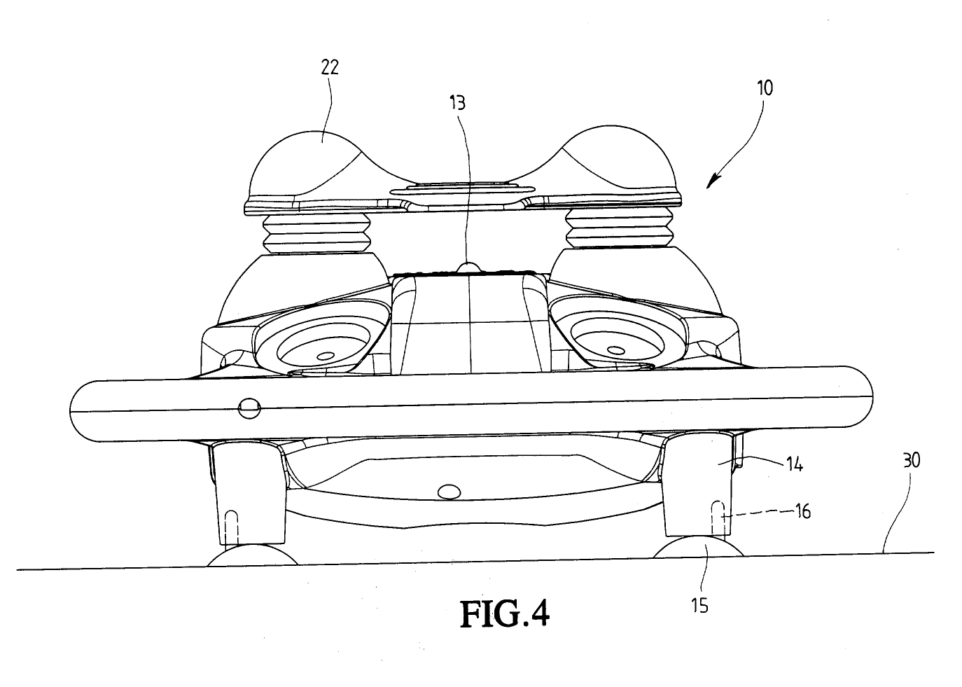

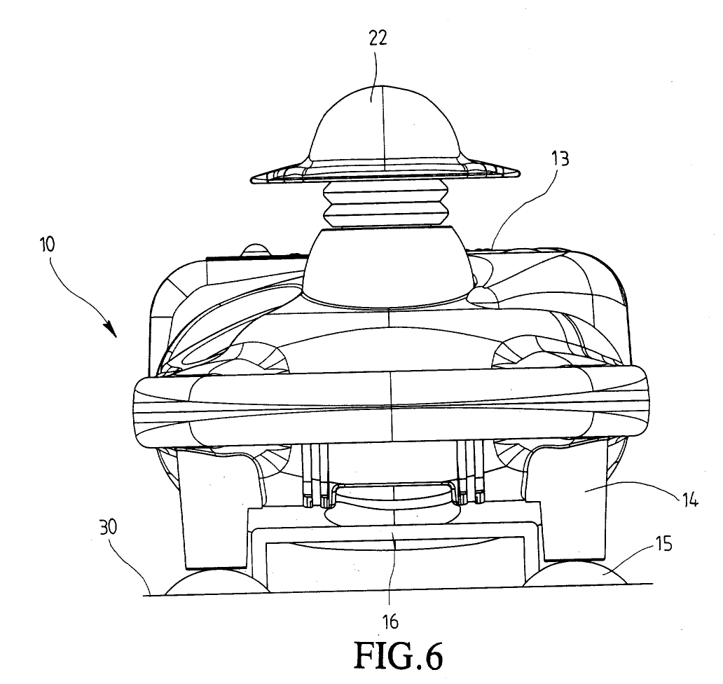

Referring to FIGS. 1, 2, 4 and 6, the massage machine 10 of the present invention comprises a casing in which two massage members 20 are movably connected thereto and driven by cam mechanisms which is not shown. Four legs 14 are connected to an underside of the casing and each leg 14 has a suction disk 15 connected to a distal end thereof so that the suction disks 15 can be sucked on a table 30. Once the massage machine 10 is fixed on the table 30 by the suction disks 15, it will not move by the vibration. A connection bar 16 is connected between two suction disks 15.

At least one magnet 21 is embedded in a recess 201 defined in a top of each massage member 20. A far infra-red cover 13 is located between the two massage members 20. A cover 22 has two engaging portion 220 so as to respectively mount on the two massage members 20. The cover 22 is connected between the two massage members 20 so that the cover 22 restrains the two massage members 20 to move in the same way.

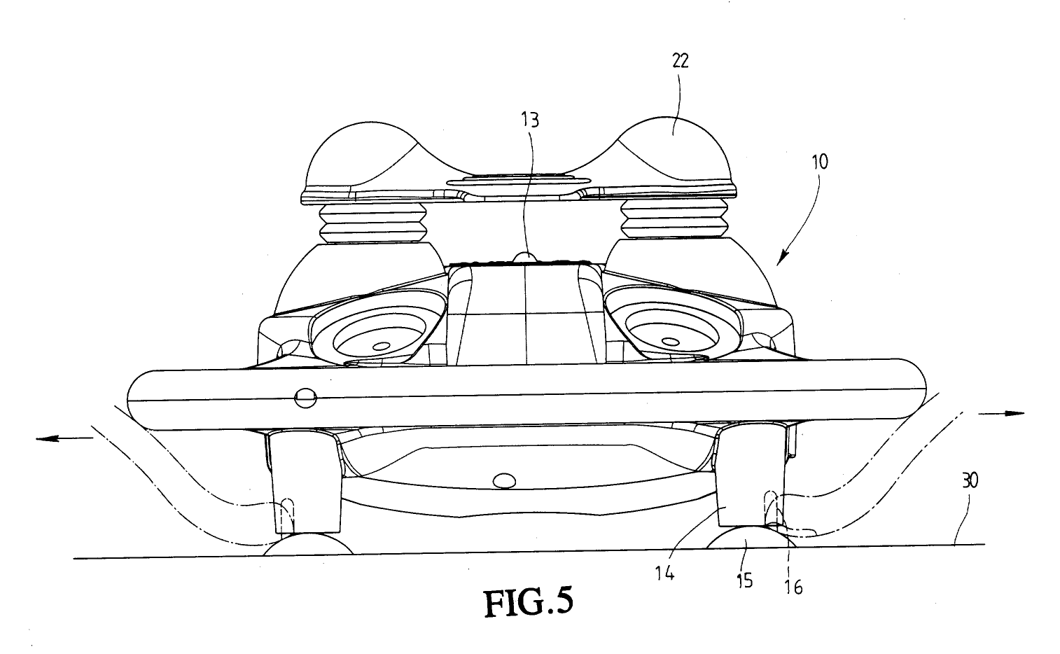

As shown in FIG. 5, the user can easily peel off the suction disks 15 by lifting the connection bar 16 by a finger.

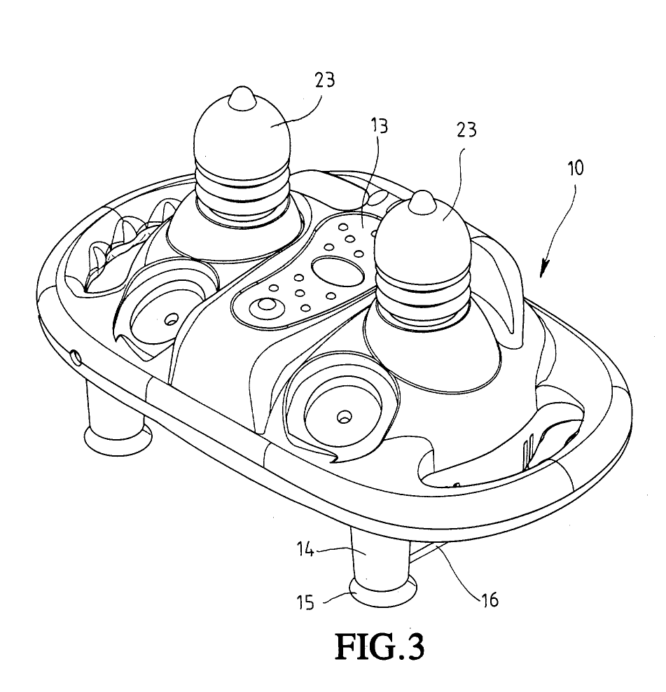

Referring to FIG. 3, each massage member 20 may have a top cap 23 mounted thereto. By this arrangement, the user may use the two massage members 20 in different ways of movement.

While we have shown and described the embodiment in accordance with the present invention, it should be clear to those skilled in the art that further embodiments may be made without departing from the scope of the present invention.

What is claimed is:

1. A massage machine comprising:
a casing having two massage members movably connected thereto and a plurality of legs connected to an underside of the casing, each leg having a suction disk connected thereto and a connection bar connected between two suction disks.

2. The massage machine as claimed in claim 1, wherein each massage member has at least one magnet embedded therein.

3. The massage machine as claimed in claim 1, wherein each massage member has a top cap mounted thereto.

4. The massage machine as claimed in claim 1 further comprising a cover which has two engaging portion so as to respectively mount on the two massage members.

5. The massage machine as claimed in claim 1 further comprising a far infra-red cover located between the two massage members.
